(19) United States
(12) Patent Application Publication
(10) Pub. No.: US 2026/0065277 A1
(43) Pub. Date: Mar. 5, 2026

(54) SYSTEMS AND METHODS FOR DATA CAPTURE AND VERIFICATION OF DOCUMENTS

(71) Applicant: TERRI PAGE, PEMBROKE PINES, FL (US)

(72) Inventor: TERRI PAGE, PEMBROKE PINES, FL (US)

(21) Appl. No.: 18/920,606

(22) Filed: Oct. 18, 2024

Related U.S. Application Data
(60) Provisional application No. 63/544,741, filed on Oct. 18, 2023.

(51) Int. Cl. G06Q 20/40; G06Q 20/36; G06Q 20/38

(52) U.S. Cl. CPC G06Q 20/4014; G06Q 20/36; G06Q 20/385; G06Q 2220/00

(57) ABSTRACT

Systems and methods for data capture and verification of documents. One such system may include a processor configured to execute a verification system comprising initiation, collection, data extraction, contracting, data encryption, and authentication modules. Other such systems may include a software application comprising similar modules. The systems may further comprise disbursement modules, repository modules, and rewards modules. Further, the systems may be operative to create an electronic wallet configured to receive at least one asset. Moreover, some embodiments of the present invention include a method comprising receiving at least one instrument; extracting a first set of information from the same; generating at least one smart contract; encrypting the first set of information into the at least one smart contract; and verifying at least one individual's identity via a first verification step and a second verification step.

### CLAIM OF PRIORITY

The present patent application hereby makes a claim of priority to a currently pending U.S. provisional patent application having Ser. No. 63/544,741 and a filing date of Oct. 18, 2023, which is hereby incorporated in its entirety.

### BACKGROUND OF THE INVENTION

### Field of the Invention

The present invention is directed to systems and methods for data capture and verification of documents.

### Description of the Related Art

Commercial transactions have long served as the backbone of commerce, facilitating the exchange of goods and services since the dawn of trade. In this regard, and with particular focus on the last several decades, such transactions have primarily been conducted through a variety of means, including checks, money orders, gift cards, credit cards, contracts, and other instruments. However, although these various means have served their purpose, successfully facilitating commercial transactions across a variety of contextual circumstances, the state of the art in these conventional instruments and payment/recordkeeping systems presents several challenges and pitfalls that compromise their security and reliability.

As an initial matter, traditional instruments (e.g., negotiable instruments) often lack robust security measures. In this regard, traditional instruments often rely on basic security features that are susceptible to counterfeiting, alteration, and unauthorized use. For example, checks and money orders may be forged or altered, while gift cards can be easily duplicated or tampered with. Even credit cards, which have evolved with embedded chips and magnetic stripes, are not immune to skimming or “card-not-present” fraud.

Additionally, and in furtherance of the above, traditional instruments are inherently vulnerable to fraud and malicious activities. More specifically, the limited security measures of traditional payment methods make them attractive targets for fraudsters and malicious actors. Identity theft, account takeover, and unauthorized transactions are prevalent issues that plague both consumers and various commercial institutions. As a result, the lack of real-time verification and authentication processes can lead to delayed detection of fraudulent activities, resulting in significant financial losses and, in many cases, reputational damage.

Moreover, the use of traditional instruments is often inefficient and inconsistent, at least with particular regard to verification and authentication processes. In this regard, manual verification methods are time-consuming and error-prone, leading to delays and disputes. Moreover, different payment systems often operate wholly independently, lacking interoperability and creating friction in cross-platform transactions.

Given these challenges and pitfalls in the current state of the art, there is a compelling need for an improvement in commercial transaction security and integrity. Modern technologies, such as advanced encryption algorithms, biometric authentication, and real-time transaction monitoring, offer promising solutions to enhance the security and reliability of such transactions. An advanced verification system that incorporates these technologies can effectively mitigate the risks associated with fraud and malicious activities, providing consumers and commercial institutions with greater peace of mind and confidence in their transactions. Thus, there exists a significant opportunity for innovation and improvement in the art to address these pressing issues and advance the field of commercial transaction security.

As such, there is a need in the art for an invention which may provide at least one system and/or method for securely, efficiently, and effectively verifying documents. Specifically, there is a need in the art for a solution which can: digitally receive one or more instruments, whether uploaded by a user of the solution or otherwise; extract key data points from the one or more instruments, at least in part as a security measure to ensure the key data points are identical when the one or more instruments are presented (e.g., for payment); generate at least one smart contract between the user and at least one additional party; encrypt the key data points from the one or more instruments into the at least one smart contract, done at least in part to protect the sensitive information incorporated therein; and verify the user's identity, done primarily to ensure the identity of the user matches the identity of the recipient of the one or more instruments. Moreover, there is a need in the art for a solution which is configured so as to ensure the party in interest may easily and quickly access and distribute its asset(s); provides a system of rewards for those who use the solution; and is able to be easily integrated with operating systems present in most client devices, thereby ensuring the present invention can be used all around the world.

### SUMMARY OF THE INVENTION

In view of the disadvantages that come with the use of currently available systems and methods for data capture and verification of documents, the present invention is directed to at least one system and at least one method for verification of documents which, inter alia, securely, efficiently, and effectively verify such documents.

As used herein, the term “wallet” can refer to one or more software programs and/or hardware devices that allow users to securely store, manage, and/or interact with one or more digital assets. As may be understood by one skilled in the art, the term “wallet” includes the terms “hot wallet,” which may refer to a type of wallet that is connected to the internet and is readily accessible for online transactions, exchanges, and other activities (e.g., a wallet that is actively used for online transactions and trading); “cold wallet,” which can refer to a type of wallet that is completely offline and disconnected from the internet, thereby providing a more secure option compared to its “hot” counterpart; and “hybrid wallet,” which can refer to a type of wallet that combines features of “hot” and “cold” wallets, thereby keeping a portion of a user's digital assets readily accessible for transactions and trading (i.e., features similar to a “hot” wallet) while simultaneously securely storing the bulk of a user's digital assets offline to protect the user from online threats (i.e., features similar to a “cold” wallet). Additionally, as used herein, the phrase “at least one instrument” encompasses various documents (e.g., contracts, tickets, etc.), data, and electronic transactions, but also financial instruments—including checks, money orders, credit cards, gift cards, and the like—and encompasses images and scans of the same, but may also include any other tangible or digital representations thereof. Furthermore, as used herein, the phrase “client device” may include one or more of the following devices: mobile devices, such as mobile phones; tablet computers; laptop computers; PDAs; wearables, such as smart watches; automated teller machines (ATMs); and other similar self-service terminals designed for financial transactions. Moreover, the term “asset” may refer to any valuable resource or property that holds economic value, including but not limited to money, securities, commodities, intellectual property, and other similar items or rights that can be owned or controlled and are expected to provide future benefit or value. Lastly, the term “smart contract” can refer to a self-executing computer program —traditionally built on blockchain technology and designed for trustless and automated execution of agreements between parties—that automatically enforces and executes the terms of a contract when certain predefined conditions are met. In all of the foregoing, the terms and/or phrases “wallet,” “hot wallet,” “cold wallet,” “hybrid wallet,” “at least one instrument,” “client device,” “asset,” and “smart contract” are described only by way of non-limiting example.

In more specific terms, the system for verification of documents may comprise a processor disposed in connection with a memory having computer-readable instructions stored thereon. In at least one embodiment of the present invention, the processor may be configured to execute a verification system (e.g., a computer-implemented system such as a web or application-based platform) that may provide a variety of functionality. Such a verification system may comprise a variety of different subsystems and modules configured to provide a variety of functionality. By way of non-limiting example, at least some embodiments of the present invention comprise a variety of modules, including an initiation module, a collection module, a data extraction module, a contracting module, a data encryption module, an authentication module, a disbursement module, a repository module, and/or a reward module.

As to embodiments of the present invention wherein the processor is configured to execute a verification system via an application-based platform (e.g., a software application) configured to be executed on a memory of a client device, the software application may be operative to: be accessed by at least one individual; register the at least one individual; digitally receive at least one instrument; extract a first set of information from the at least one instrument; generate at least one smart contract between the at least one individual and at least one additional party; encrypt the first set of information into the at least one smart contract; and verify the at least one individual's identity. By way of non-limiting example, and as may be understood, an “at least one individual” may, at times, be synonymous with the terms “user” and/or “relevant entity.” By way of additional non-limiting example, the client device may be configured to communicate with other client devices over a network. Furthermore, in such embodiments wherein the client device is configured to communicate with other client devices over a network, the client device may also interact with an application server.

With regard to the initiation module, in at least some embodiments of the present invention, the initiation module is configured to register at least one individual. By way of non-limiting example, the initiation module may be configured to receive contact information (e.g., phone number, email address, etc.), billing information, and other relevant information of the at least one individual (e.g., bank account information, etc.). In some such embodiments where the initiation module is configured to receive contact information, the at least one individual may be required to provide his or her contact information (e.g., phone number, etc.) to utilize the present invention. Additionally, in at least one such embodiment wherein the present invention comprises an initiation module, the initiation module may also facilitate the at least one individual's password reclamation for further user authentication. Furthermore, in at least some embodiments of the present invention, the initiation module is also operative to allow an already registered at least one individual to login to the at least one individual's account.

With regard to the collection module, in at least some embodiments of the present invention, the collection module is operative to digitally receive at least one instrument. By way of non-limiting example, the collection module is operative to digitally receive the at least one instrument from the client device—which may be accomplished via a plethora of digital and physical means, including, but not limited to, digital upload via mobile phone camera or PDF scan. With regard to the data extraction module, in at least some embodiments of the present invention, the data extraction module is operative to extract a first set of information from the at least one instrument. In at least some embodiments of the present invention, the data extraction module is operative to analyze at least one instrument and extract pertinent data from the same—at times with the assistance of one or more artificial intelligence components which assist in the enhancement of such data extraction. By way of non-limiting example, at least one individual may upload a photo of a check (i.e., a check made out to the at least one individual), and the data extraction module of the present invention may extract certain data (e.g., amount, check number, account number, etc.) from the check. In such an embodiment (e.g., a photo upload of at least one financial instrument), and by way of additional non-limiting example, the present invention may require the at least one individual to manually input the at least one individual's contact information (e.g., phone number, etc.) to link the at least one individual to the at least one instrument.

With regard to the contracting module, in at least some embodiments of the present invention, the contracting module is operative to generate at least one smart contract between the at least one individual and at least one additional party. In many embodiments, the at least one smart contract's parameters incorporate the verification of certain data points (e.g., information includes the first set of information) of the at least one instrument. In many embodiments still, the at least one smart contract may also incorporate one or more features that provide for replication of such certain data points of the at least one instrument wherever and whenever the at least one instrument is presented for payment, authentication, and/or verification. By way of non-limiting example, the at least one smart contract is stored on a blockchain.

With regard to the data encryption module, in at least some embodiments of the present invention, the data encryption module is operative to encrypt the first set of information into the at least one smart contract. By way of non-limiting example—and in at least some embodiments of the present invention wherein the at least one smart contract is stored on a blockchain—when an at least one instrument is presented for payment, authentication, and/or verification (e.g., at a bank or other institution), upon the relevant entity's analyzing of the at least one instrument (e.g., via scan or other similar means), the data points (e.g., the first set of information) may interface with the at least one encrypted smart contract (i.e., the at least one smart contract which incorporates and/or includes the first set of information encrypted into the same), thereby displaying the data points to the relevant entity for initial authorization. In such an embodiment, the data points displayed to the relevant entity may be required to exactly match the data points of the at least one encrypted smart contract in order to fully execute the at least one encrypted smart contract.

With regard to the authentication module, in at least some embodiments of the present invention, the authentication module is operative to verify the at least one individual's identity. By way of non-limiting example, the authentication module may comprise a first verification step, the first verification step comprising generating a code and presenting the code to the at least one individual. In such embodiments, the code may be selected from a list of codes comprising text message codes, quick-response (QR) codes, and barcodes. Moreover, in at least some such embodiments of the present invention, the at least one individual may be required to present the code to a relevant entity (e.g., an employee of a financial institution) to be independently verified (e.g., via scan). By way of additional non-limiting example, the authentication module may comprise a second verification step, the second verification step comprising verifying the at least one individual's identity via confirmation of at least one biological characteristic of the at least one individual. In such embodiments, the at least one biological characteristic of the at least one individual may be procured via one of several means, including, but not limited to, a biometric scan of one or more of the at least one individual's palm(s). In at least some such embodiments of the present invention, upon completion of the second verification step, the transaction will be deemed completed, and, in at least some additional embodiments, the party/payor (i.e., of the at least one instrument) may have the relevant asset(s) automatically drafted from the party/payor's relevant account(s).

In at least some embodiments of the present invention, the software application is operative to create an electronic wallet, the electronic wallet tied to the at least one individual and configured to receive at least a portion of at least one asset. By way of non-limiting example, the electronic wallet may be similar to a virtual bank account or other similar source, and, in some instances, the electronic wallet may be tied to one or more financial institutions, wherein the one or more financial institutions serve in a depository role. By way of additional non-limiting example, the electronic wallet may be viewable by the at least one individual, may allow the at least one individual to transfer one or more assets to other entities (e.g., financial entities) or into other forms of currency (e.g., cryptocurrency), and may allow the at least one individual to view a transaction log involving the at least one individual's electronic wallet.

With specific regard to the disbursement module, in at least some embodiments of the present invention, the disbursement module is operative to request a first amount of at least one asset to be disbursed to the at least one individual. In many instances, and by way of non-limiting example, the at least one individual will respond in a manner that indicates the at least one individual wishes for the entirety of the at least one asset to be disbursed to the at least one individual (i.e., no portion of the at least one asset will remain undisbursed). In other instances, however, the at least one individual may respond in a manner that indicates the at least one individual wishes for less than the entirety of the at least one asset to be disbursed to the at least one individual (i.e., at least a portion of the at least one asset will remain undisbursed). In such instances—and as disclosed above—the software application, which may be operative to create an electronic wallet, may be further operative to deposit a second amount of the at least one asset (e.g., via the disbursement module) into the electronic wallet.

With regard to the repository module, in at least some embodiments of the present invention, the repository module is operative to store identification information of the at least one individual, the identification information comprising at least one phone number of the at least one individual and, in many embodiments, the at least one biological characteristic of the at least one individual. By way of non-limiting example, the repository module may store such identification information (e.g., the at least one biological characteristic of the at least one individual) so that when the at least one individual's contact information (e.g., phone number) is used for one or more other instruments, the identification information is accessed to assist in the expedience of verifying the transaction. In some such embodiments, the identification information may automatically be tied to the respective at least one smart contract. By way of additional non-limiting example, should the at least one individual's contact information change, the present invention may provide for a means of connecting the relevant identification information to the at least one individual's new contact information.

Moreover, by way of non-limiting example, in embodiments of the present invention which may be operative to create an electronic wallet and which comprise a repository module, an at least one individual may be able to access an amount of at least one asset (i.e., stored in the electronic wallet) via verifying the at least one individual's at least one biological characteristic at a relevant institution (e.g., ATM, bank, etc.). In a similar vein, the present invention may provide for a means for one or more individuals to cash, deposit, endorse, and/or process various types of instruments via simply verifying the one or more individuals'at least one biological characteristic, thereby rendering such physical instruments (e.g., checks, other similar financial instruments, etc.) obsolete. By way of additional non-limiting example, an at least one individual may ultimately be able to upload the one or more instruments into a device, such as an ATM, and have the options of, inter alia, withdrawing at least a portion of the at least one asset (e.g., in cash) or depositing the same into the at least one individual's electronic wallet. In such embodiments, upon the uploading of the one or more instruments into the relevant device, the party/payor (i.e., of the at least one instrument) may have the relevant asset(s) automatically drafted from the party/payor's relevant account(s).

With regard to the reward module, in at least some embodiments of the present invention, the reward module is operative to provide at least one reward to the at least one individual. By way of non-limiting example, the reward module may be operative to provide at least one reward (e.g., a rewards credit card number) to the at least one individual after a pre-set number of transactions. Similarly, and by way of additional non-limiting example, in embodiments of the present invention wherein the at least one instrument is a credit card or gift card (or other similar instrument), the reward module may be operative to provide at least one reward to the at least one individual after the at least one individual has exhausted the relevant asset(s) of the gift card and/or reached the relevant credit limit for the credit card.

The attendant method of the present invention, on the other hand, includes a method for verification of documents. One or more embodiments of the present invention include a method comprising: receiving at least one instrument; extracting a first set of information from the at least one instrument; generating at least one smart contract between an at least one individual and at least one additional party, the at least one smart contract stored on a blockchain; encrypting the first set of information into the at least one smart contract; and verifying the at least one individual's identity via a first verification step—the first verification step comprising generating a code and presenting the code to the at least one individual—and a second verification step—the second verification step comprising confirming at least one biological characteristic of the at least one individual. By way of non-limiting example, one or more embodiments of the present invention provide for a method further comprising storing identification information of the at least one individual, the identification information comprising contact information (e.g., at least one phone number) of the at least one individual and the at least one biological characteristic of the at least one individual.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be made to the following detailed description taken in connection with the accompanying drawings in which:

FIG. 1 is a schematic representation in block form of at least one embodiment of the present invention.

FIG. 2 is a schematic representation in block form of at least one embodiment of the present invention.

FIG. 3 is a schematic representation in block form of at least one embodiment of the present invention.

FIG. 4 is a schematic representation in block form representing at least one method embodiment of the present invention.

Like reference numerals refer to like parts throughout the several views of the drawings.

### DETAILED DESCRIPTION OF THE PREFERRED EMBODIMENT

The invention now will be described more fully hereinafter with reference to the accompanying drawings in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

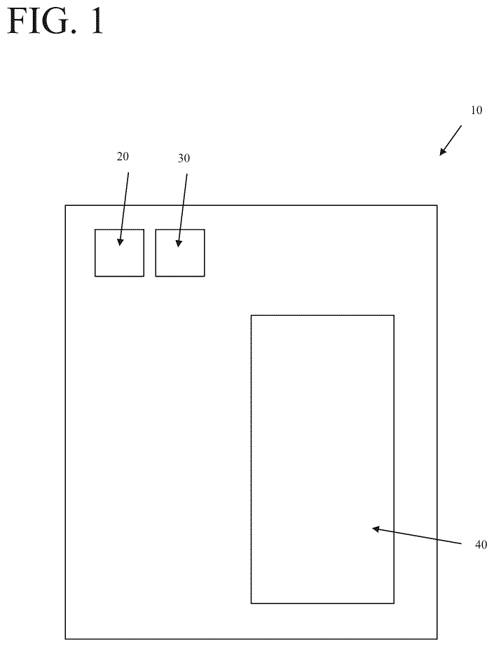

Turning now descriptively to the figures, FIG. 1 illustrates a system for verification of documents 10 which may comprise a processor 20 disposed in connection with a memory 30 having computer-readable instructions stored thereon. In at least one embodiment of the present invention, the processor may be configured to execute a verification system (e.g., a computer-implemented system such as a web or application-based platform) 40 that may provide a variety of functionality. Such a verification system 40 may comprise a variety of different subsystems and modules configured to provide a variety of functionality. By way of non-limiting example, at least some embodiments of the present invention comprise a variety of modules, including an initiation module, a collection module, a data extraction module, a contracting module, a data encryption module, an authentication module, a disbursement module, a repository module, and/or a reward module.

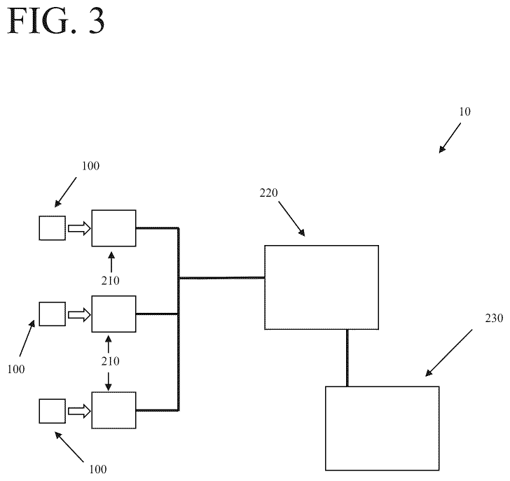

As to embodiments of the present invention wherein the processor is configured to execute a verification system via an application-based platform (e.g., a software application) configured to be executed on a memory of a client device 210, illustrated in FIG. 3, the software application 100 may be operative to: be accessed by at least one individual; register the at least one individual; digitally receive at least one instrument; extract a first set of information from the at least one instrument; generate at least one smart contract between the at least one individual and at least one additional party; encrypt the first set of information into the at least one smart contract; and verify the at least one individual's identity. By way of non-limiting example, also seen in FIG. 3, the client device 210 may be configured to communicate with other client devices over a network 220. Furthermore, in such embodiments wherein the client device 210 is configured to communicate with other client devices over a network 220, as per FIG. 3, the client device may also interact with an application server 230.

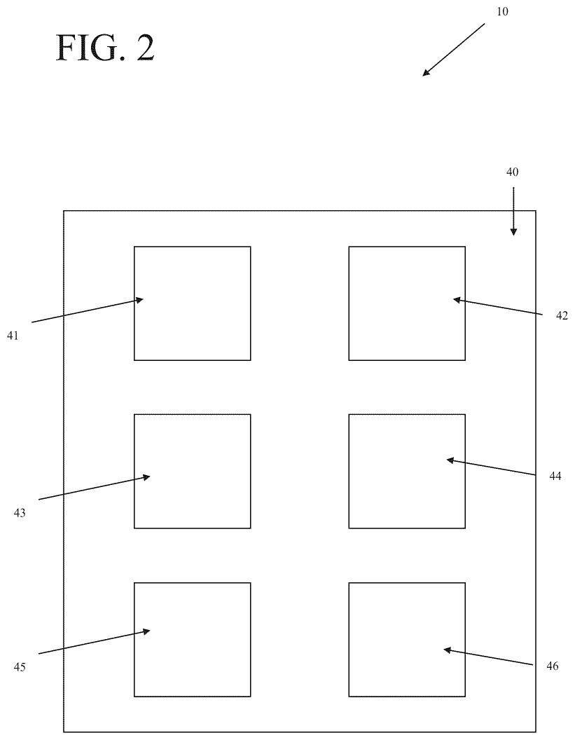

With regard to the initiation module, seen in FIG. 2 and represented as 41, in at least some embodiments of the present invention, the initiation module 41 is configured to register an at least one individual of the present invention. By way of non-limiting example, the initiation module 41 may be configured to receive contact information (e.g., phone number, email address, etc.), billing information, and other relevant information of the at least one individual (e.g., bank account information, documents, contracts, etc.). In some such embodiments where the initiation module 41 is configured to receive contact information, an at least one individual may be required to provide his or her contact information (e.g., phone number, etc.) to utilize the present invention. Additionally, in at least one such embodiment wherein the present invention comprises an initiation module 41, the initiation module 41 may also facilitate an at least one individual's password reclamation for further at least one individual authentication. Furthermore, in at least some embodiments of the present invention, the initiation module 41 is also operative to allow an already registered at least one individual of the present invention to login to the at least one individual's account.

With regard to the collection module, seen in FIG. 2 and represented as 42, in at least some embodiments of the present invention, the collection module 42 is operative to digitally receive at least one instrument. By way of non-limiting example, the collection module 42 is operative to digitally receive the at least one instrument from the client device—which may be accomplished via a plethora of digital and physical means, including, but not limited to, digital upload via mobile phone camera or PDF scan.

With regard to the data extraction module, seen in FIG. 2 and represented as 43, in at least some embodiments of the present invention, the data extraction module 43 is operative to extract a first set of information from the at least one instrument. In at least some embodiments of the present invention, the data extraction module 43 is operative to analyze at least one instrument and extract pertinent data from the same—at times with the assistance of one or more artificial intelligence components which assist in the enhancement of such data extraction (e.g., optical character recognition software with enhanced artificial intelligence features). By way of non-limiting example, an at least one individual may upload a photo of a check (i.e., a check made out to the at least one individual), and the data extraction module 43 of the present invention may extract certain data (e.g., amount, check number, account number, etc.) from the check. In such an embodiment (e.g., a photo upload of at least one financial instrument), and by way of additional non-limiting example, the present invention may require the at least one individual to manually input the at least one individual's contact information (e.g., phone number) to link the at least one individual to the at least one instrument. In other embodiments, the data extraction module requires at least one individual to manually upload at least one file (e.g., a .csv file) from a client device.

With regard to the contracting module, seen in FIG. 2 and represented as 44, in at least some embodiments of the present invention, the contracting module 44 is operative to generate at least one smart contract between the at least one individual and at least one additional party. In many embodiments, the at least one smart contract's parameters incorporate the verification of certain data points (e.g., information includes the first set of information) of the at least one instrument. In many embodiments still, the at least one smart contract may also incorporate one or more features that provide for replication of such certain data points of the at least one instrument wherever and whenever the at least one instrument is presented for payment, authentication, and/or verification. By way of non-limiting example, the at least one smart contract is stored on a blockchain.

In other embodiments, the contracting module is not operative to generate at least one smart contract. In such instances, a pre-deployed smart contract may be utilized separate from the contracting module. By way of additional non-limiting example, the pre-deployed smart contract may include several pre-defined terms, including but not limited to: parties to the pre-deployed smart contract (e.g., payor, payee, encashment user, check, store, etc.); attributes (e.g., wallet address, name, status, email, entity name, phone, timestamp, ID document hash, user type, transaction ID, check hash, store ID, location, etc.); events (e.g., payor added, payee added, encashment user added, check added, check status updated, store added, etc.); and functional terms (e.g., adding and retrieving details for payor, payee, encashment user, check, and store; updating check status; and verifying check validity and payee authenticity).

In furtherance of the same, in embodiments of the present invention wherein at least one instrument is presented for payment, authentication, and/or verification, and by way of non-limiting example, certain data may need to be replicated. In this regard, such data may comprise: payor information (e.g., name and blockchain wallet address), payee information (e.g., name and blockchain wallet address), amount, check number, transaction ID, status, timestamp, and/or facility (e.g., check-cashing business, bank, etc.).

With regard to the data encryption module, seen in FIG. 2 and represented as 45, in at least some embodiments of the present invention, the data encryption module 45 is operative to encrypt the first set of information into the at least one smart contract. By way of non-limiting example—and in at least some embodiments of the present invention wherein the at least one smart contract is stored on a blockchain—when an at least one instrument is presented for payment, authentication, and/or verification (e.g., at a bank or other institution), upon the relevant entity's analyzing of the at least one instrument (e.g., via scan or other similar means), the data points (e.g., the first set of information) may interface with the at least one encrypted smart contract (i.e., the at least one smart contract which incorporates and/or includes the first set of information encrypted into the same), thereby displaying the data points to the relevant entity for initial authorization. In such an embodiment, the data points displayed to the relevant entity may be required to exactly match the data points of the at least one encrypted smart contract in order to fully execute the at least one encrypted smart contract. In other embodiments, the data encryption module simply utilizes at least one public and/or private key to provide access to the first set of information.

With regard to the authentication module, seen in FIG. 2 and represented as 46, in at least some embodiments of the present invention, the authentication module 46 is operative to verify the at least one individual's identity. By way of non-limiting example, the authentication module 46 may comprise a first verification step, the first verification step comprising generating a code and presenting the code to the at least one individual. In such embodiments, the code may be selected from a list of codes comprising text message codes, quick-response (QR) codes, and barcodes. Moreover, in at least some such embodiments of the present invention, the at least one individual may be required to present the code to a relevant entity (e.g., an employee of a financial institution) to be independently verified (e.g., via scan). By way of additional non-limiting example, the authentication module 46 may comprise a second verification step, the second verification step comprising verifying the at least one individual's identity via confirmation of at least one biological characteristic of the at least one individual. In such embodiments, the at least one biological characteristic of the at least one individual may be procured via one of several means, including, but not limited to, a biometric scan of one or more of the at least one individual's palm(s). In at least some such embodiments of the present invention, upon completion of the second verification step, the transaction will be deemed completed, and, in at least some additional embodiments, the party/payor (i.e., of the at least one instrument) may have the relevant asset(s) automatically drafted from the party/payor's relevant account(s).

In at least some embodiments of the present invention, the software application is operative to create an electronic wallet, the electronic wallet tied to the at least one individual and configured to receive at least a portion of at least one asset. By way of non-limiting example, the electronic wallet may be similar to a virtual bank account or other similar source, and, in some instances, the electronic wallet may be tied to one or more financial institutions, wherein the one or more financial institutions serve in a depository role. By way of additional non-limiting example, the electronic wallet may be viewable by the at least one individual, may allow the at least one individual to transfer one or more assets to other entities (e.g., financial entities) or into other forms of currency (e.g., cryptocurrency), and may allow the at least one individual to view a transaction log involving the at least one individual's electronic wallet.

With specific regard to the disbursement module, in at least some embodiments of the present invention, the disbursement module is operative to request a first amount of at least one asset to be disbursed to the at least one individual. In many instances, and by way of non-limiting example, the at least one individual will respond in a manner that indicates the at least one individual wishes for the entirety of the at least one asset to be disbursed to the at least one individual (i.e., no portion of the at least one asset will remain undisbursed). In other instances, however, the at least one individual may respond in a manner that indicates the at least one individual wishes for less than the entirety of the at least one asset to be disbursed to the at least one individual (i.e., at least a portion of the at least one asset will remain undisbursed). In such instances—and as disclosed above—the software application, which may be operative to create an electronic wallet, may be further operative to deposit a second amount of the at least one asset (e.g., via the disbursement module) into the electronic wallet.

With regard to the repository module, in at least some embodiments of the present invention, the repository module is operative to store identification information of the at least one individual, the identification information comprising at least one phone number of the at least one individual and, in many embodiments, the at least one biological characteristic of the at least one individual. By way of non-limiting example, the repository module may store such identification information (e.g., the at least one biological characteristic of the at least one individual) so that when the at least one individual's contact information (e.g., phone number, etc.) is used for one or more other instruments, the identification information is accessed to assist in the expedience of verifying the transaction. In some such embodiments, the identification information may automatically be tied to the respective at least one smart contract. By way of additional non-limiting example, should the at least one individual's contact information change, the present invention may provide for a means of connecting the relevant identification information to the at least one individual's new contact information.

Moreover, by way of non-limiting example, in embodiments of the present invention which may be operative to create an electronic wallet and which comprise a repository module, an at least one individual may be able to access an amount of at least one asset (i.e., stored in the electronic wallet) via verifying the at least one individual's at least one biological characteristic at a relevant institution (e.g., ATM, bank, etc.). In a similar vein, the present invention may provide for a means for one or more individuals to cash, deposit, endorse, and/or process various types of instruments via simply verifying the one or more individuals'at least one biological characteristic, thereby rendering such physical instruments (e.g., checks, other similar financial instruments, etc.) obsolete. By way of additional non-limiting example, an at least one individual may ultimately be able to upload the one or more instruments into a device, such as an ATM, and have the options of, inter alia, withdrawing at least a portion of the at least one asset (e.g., in cash) or depositing the same into the at least one individual's electronic wallet. In such embodiments, upon the uploading of the one or more instruments into the relevant device, the party/payor (i.e., of the at least one instrument) may have the relevant asset(s) automatically drafted from the party/payor's relevant account(s).

With regard to the reward module, in at least some embodiments of the present invention, the reward module is operative to provide at least one reward to the at least one individual. By way of non-limiting example, the reward module may be operative to provide at least one reward (e.g., a rewards credit card number) to the at least one individual after a pre-set number of transactions. Similarly, and by way of additional non-limiting example, in embodiments of the present invention wherein the at least one instrument is a credit card or gift card (or other similar instrument), the reward module may be operative to provide at least one reward to the at least one individual after the at least one individual has exhausted the relevant asset(s) of the gift card and/or reached the relevant credit limit for the credit card.

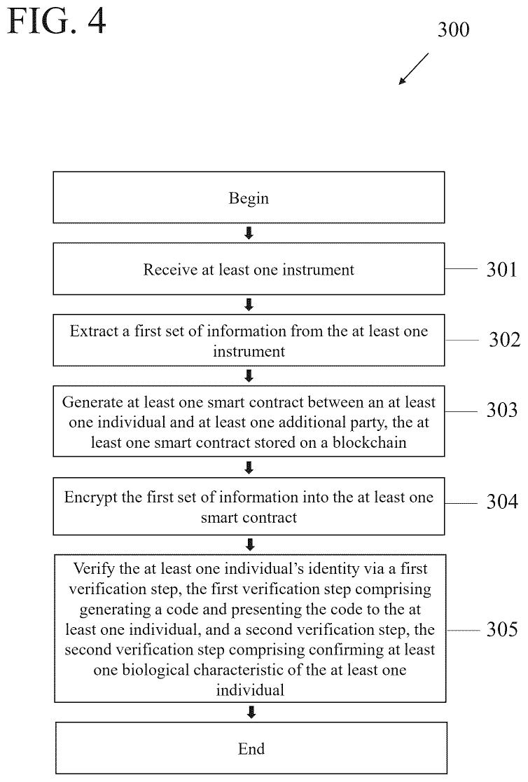

The attendant method of the present invention, on the other hand, seen in FIG. 4, includes a method for verification of documents 300. One or more embodiments of the present invention include a method comprising: receiving at least one instrument 301; extracting a first set of information from the at least one instrument 302; generating at least one smart contract between an at least one individual and at least one additional party, the at least one smart contract stored on a blockchain 303; encrypting the first set of information into the at least one smart contract 304; and verifying the at least one individual's identity via a first verification step—the first verification step comprising generating a code and presenting the code to the at least one individual—and a second verification step—the second verification step comprising confirming at least one biological characteristic of the at least one individual 305. By way of non-limiting example, one or more embodiments of the present invention provide for a method further comprising storing identification information of the at least one individual, the identification information comprising contact information (e.g., at least one phone number) of the at least one individual and the at least one biological characteristic of the at least one individual.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for verification of documents, the system comprising:
a processor disposed in connection with a memory having computer-readable instructions stored thereon,
said processor configured to execute a verification system, said verification system comprising:
an initiation module, said initiation module operative to register an at least one individual;
a collection module, said collection module operative to digitally receive at least one instrument;
a data extraction module, said data extraction module operative to extract a first set of information from the at least one instrument;
a contracting module, said contracting module operative to generate at least one smart contract between the at least one individual and at least one additional party;
a data encryption module, said data encryption module operative to encrypt the first set of information into the at least one smart contract; and
an authentication module, said authentication module operative to verify the at least one individual's identity.

2. The system of claim 1, wherein said collection module is operative to digitally receive the at least one instrument from a client device.

3. The system of claim 1, wherein the at least one smart contract is stored on a blockchain.

4. The system of claim 1, wherein said authentication module comprises a first verification step, said first verification step comprising generating a code and presenting the code to the at least one individual.

5. The system of claim 4, wherein the code is selected from a list of codes comprising text message codes, quick-response (QR) codes, and barcodes.

6. The system of claim 4, wherein said authentication module comprises a second verification step, said second verification step comprising verifying the at least one individual's identity via confirmation of at least one biological characteristic of the at least one individual.

7. The system of claim 6, wherein said verification system further comprises a repository module, said repository module configured to store identification information of the at least one individual, the identification information comprising at least one phone number of the at least one individual and the at least one biological characteristic of the at least one individual.

8. The system of claim 1, wherein said verification system further comprises a disbursement module, said disbursement module operative to request a first amount of at least one asset to be disbursed to the at least one individual.

9. The system of claim 8, wherein said verification system is operative to create an electronic wallet, said electronic wallet tied to the at least one individual and configured to receive at least a portion of the at least one asset.

10. The system of claim 9, wherein said disbursement module is further operative to deposit a second amount of the at least one asset into said electronic wallet.

11. The system of claim 1, wherein said verification system further comprises a reward module, said rewards module configured to provide at least one reward to the at least one individual.

12. A system for verification of documents, the system comprising:
a software application configured to be executed on a memory of a client device;
said software application configured to be accessed by at least one individual;
said software application operative to register the at least one individual;
said software application further operative to digitally receive at least one instrument;
said software application further operative to extract a first set of information from the at least one instrument;
said software application further operative to generate at least one smart contract between the at least one individual and at least one additional party;
said software application further operative to encrypt the first set of information into the at least one smart contract; and
said software application further operative to verify the at least one individual's identity.

13. The system of claim 12, wherein said software application is further operative to digitally receive the at least one instrument from the client device.

14. The system of claim 12, wherein the at least one smart contract is stored on a blockchain.

15. The system of claim 12, wherein said software application is further operative to verify the at least one individual's identity via a first verification step, said first verification step comprising generating a code and presenting the code to the at least one individual.

16. The system of claim 15, wherein the code is selected from a list of codes comprising text message codes, quick-response (QR) codes, and barcodes.

17. The system of claim 15, wherein said software application is further operative to verify the at least one individual's identity via a second verification step, said second verification step comprising verifying the at least one individual's identity via confirmation of at least one biological characteristic of the at least one individual.

18. The system of claim 17, wherein said software application is further operative to store identification information of the at least one individual, the identification information comprising at least one phone number of the at least one individual and the at least one biological characteristic of the at least one individual.

19. The system of claim 12, wherein said software application is further operative to request a first amount of at least one asset to be disbursed to the at least one individual.

20. The system of claim 19, wherein said software application is further operative to create an electronic wallet, said electronic wallet tied to the at least one individual and configured to receive at least a portion of the at least one asset.

21. The system of claim 20, wherein said software application is further operative to deposit a second amount of the at least one asset into said electronic wallet.

22. The system of claim 12, wherein said software application is further operative to provide at least one reward to the at least one individual.

23. A method for verification of documents, the method comprising:
receiving at least one instrument;
extracting a first set of information from the at least one instrument;
generating at least one smart contract between an at least one individual and at least one additional party, the at least one smart contract stored on a blockchain;
encrypting the first set of information into the at least one smart contract; and
verifying the at least one individual's identity via a first verification step, the first verification step comprising generating a code and presenting the code to the at least one individual, and a second verification step, the second verification step comprising confirming at least one biological characteristic of the at least one individual.

24. The method of claim 19, further comprising storing identification information of the at least one individual, the identification information comprising at least one phone number of the at least one individual and the at least one biological characteristic of the at least one individual.

25. The method of claim 19, further comprising requesting a first amount of at least one asset to be disbursed to the at least one individual.

26. The method of claim 20, further comprising creating an electronic wallet, the electronic wallet tied to the at least one individual and configured to receive at least a portion of the at least one asset.

27. The method of claim 20, further comprising depositing a second amount of the at least one asset into the electronic wallet.

28. The method of claim 19, further comprising providing at least one reward to the at least one individual.
